(19) United States
(12) Patent Application Publication
(10) Pub. No.: US 2003/0182060 A1
(43) Pub. Date: Sep. 25, 2003

(54) Device and system for preventing collision of aircraft

(76) Inventor: Robert B. Young, Camillus, NY (US)

Correspondence Address: David L. Nocilly, Esq., Hancock & Estabrook, LLP, 1500 MONY Tower I, P.O. Box 4976, Syracuse, NY, 13221-4976, US

(21) Appl. No.: 10/101,246

(22) Filed: Mar. 19, 2002

(51) Int. Cl. G08G 5/04

(52) U.S. Cl. 701/301; 342/29

(57) ABSTRACT

An apparatus and system for preventing a hijacker from intentionally causing an aircraft to crash into a structure such as a building. Protected structures or areas are equipped with transmitters which transmit a coded signal when an aircraft is detected inside a minum safe range. Upon receiving the coded signals, a protective control unit on-board the aircraft overrides any commands from the pilot cockpit and automatically diverts the aircraft to avoid a collision. When the aircraft is a safe distance from the protected structure, the protective control unit deactivates and the controls are restored to the pilot cockpit. In an alternative embodiment, the protective control unit can be activated and controlled remotely to land a hijacked aircraft.

### BACKGROUND OF THE INVENTION

1. Field of Invention

The present invention relates generally to aircraft anti-collision systems, and more particularly to a device and system for preventing the collision of an aircraft with a particular structure.

2. Description of Prior Art

Hijacked commercial airplanes have recently been used to destroy buildings or structures on American soil. These friendly air planes were hijacked and flown by hostile pilots to targets they intended to damage upon impact by the plane. For example, American airplanes were used to destroy the World Trade Center in New York City and damage the Pentagon. After hostile pilots overtook these airplanes, they were flown into their intended target by active control of the airplane's commands.

Traditional systems have been developed to avoid collisions of airplanes and other aircraft, cars, and boats. In these instances the assumption was that the pilot or captain and people in charge of the commands are “friendly” and wish to avoid any impact. These systems provide visual or auditory warning of impending impact to allow the crew time to respond to the threat. However, an aircraft can be overtaken and commanded by a hostile force, such as a hijacker, whose intent it is to crash the craft onto a given structure whether mobile or stationary. In these instances, the traditional collision avoidance systems are of no avail since the hijacker will ignore the warnings of impending collision to achieve his goal. The hijacked airplane thus becomes a weapon which ground forces are virtually powerless to respond to because of an understandable reluctance to force down a hijacked aircraft which may be occupied by innocent hostages.

3. Objects and Advantages

It is a principal object and advantage of the present invention to provide a system for preventing the collision of an aircraft with a designated structure.

It is an additional object and advantage of the present invention to provide an apparatus which can override pilot controls which will result in a collision of the aircraft.

Other objects and advantages of the present invention will in part be obvious, and in part appear hereinafter.

### SUMMARY OF THE INVENTION

The present invention comprises a system for preventing a hijacker from intentionally causing an aircraft to crash into a structure such as a building. More specifically, protected structures or areas are equipped with a transmitter capable of emitting a coded signal when detecting an aircraft flying within a given range. Upon receiving the coded signals, a protective control unit on-board the aircraft overrides any commands from the pilot cockpit and automatically diverts the aircraft to avoid a collision. When the aircraft is a safe distance from the protected structure, the protective control unit deactivates and the controls are restored to the pilot cockpit. In an alternative embodiment, the protective control unit can be activated and controlled from the ground to remotely land a hijacked aircraft.

### BRIEF DESCRIPTION OF THE DRAWINGS

FIG. 1 is a representation of a system according to the present invention.

FIG. 2 is a schematic diagram of an apparatus according to the present invention.

### DETAILED DESCRIPTION

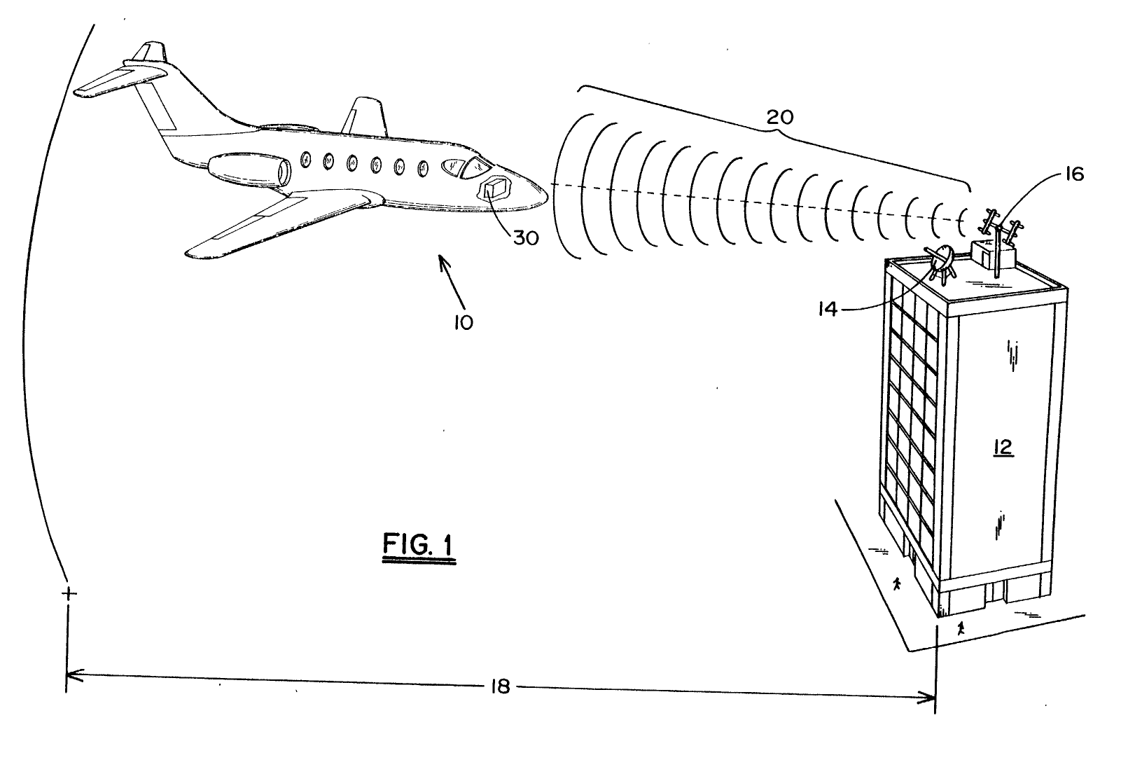

Referring now to the drawing in which like reference numerals refer to like parts throughout, there is seen in FIG. 1 a representation of the system of the present invention. A hijacked aircraft 10 is depicted as it approaches a protected structure 12. Structure 12 may be any stationary building, monument, nuclear plant, dam, or even a city or a national border.

Structure 12 could also comprise a moving object such as another plane, a train, or even an automobile or boat. Structure 12 is equipped with a radar 14 and a transmitter 16 in communication therewith. When aircraft 10 is detected by radar 14 as crossing a predetermined 1 safe perimeter 18, transmitter 16 emits a predetermined encoded signal 20.

Safe perimeter 18 can be determined by consideration of the time and space requirements necessary for given aircraft to safely execute an avoidance maneuver and avoid a collision with structure 12. Safe perimeter 18 should be demarcated well beyond the critical distance at which any aircraft could not safely execute evasive tactics to allow the present invention time to respond and execute a given maneuver. Conventional radar systems, such as an continual tracking radar or pulse radar, are capable of determining both the location and velocity to precisely locate the position of aircraft 10 relative to the perimeter 18. The timing of the transmission of signal 20 can thus be customized to the particular structure, its location, and the velocity and position of aircraft 10. Signal 20 is capable of being received by a protective control unit 30 onboard aircraft 10.

The proximity of aircraft 10 inside safe perimeter 18 may also be determined through the use of conventional distance measuring equipment, such as an interrogator and responder located on structure 12 and aircraft 10, respectively. Alternatively, structure 12 can be equipped solely with a transmitter 16 which sends coded signal 20 after detecting the proximity of aircraft 10 based upon the emission of standard navigational radar signals from aircraft 10.

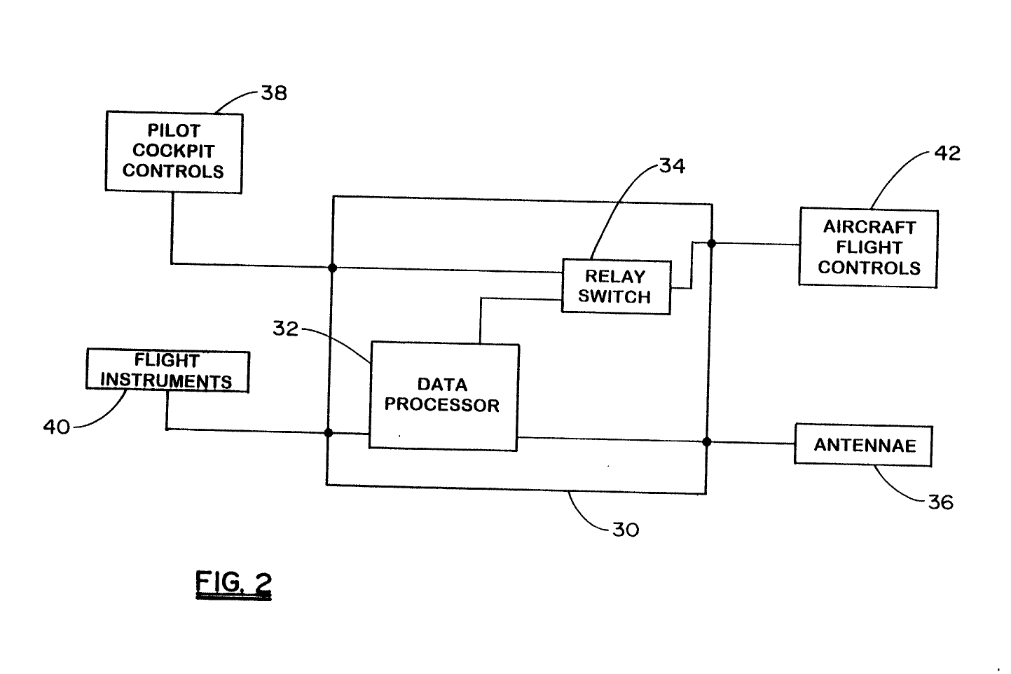

As seen in FIG. 2, control unit 30 is a self-contained system comprising a programmable data processor 32 which communicates with a relay switch 34 and a receiving antenna 36. Control unit 30 is installed in a location which is not accessible from either the crew or passenger compartment of the aircraft to prevent tampering.

Control unit 30 receives data via conventional connections from the pilot cockpit controls 38 the flight instruments 40, and the aircraft flight controllers 42. Relay switch 34 is controlled by data processor 32 and can change the source of data provided to flight controls 42. During normal operation, relay switch 34 allows data received from cockpit controls 38 to pass directly to flight controllers 42. Upon receipt by antenna 36 of signal 20, data processor 32 activates switch 34, thus disengaging cockpit controls 38.

As an alternative to activation of control unit 30 by signal 20, an onboard GPS may provide location data directly to data processor 32, which is programmed with GPS coordinates for one or more designated structures 12. When proximity of aircraft crosses safe perimeter 18, data processor 32 activates switch 34, thus alleviating the need to rely on radar 14 and transmitter 16 located on structure 12 to send signal 20.

Based on information provided by flight instruments 40, data processor 32 calculates an alternate route which avoids structure 12. Any attempts by hijackers to cause a collision are avoided as control unit 30 completely disengages cockpit controls 38 to prevent hijackers from steering aircraft 10 and then executes an evasive maneuver to avoid a collision with structure 12.

Once aircraft 10 is out of range of transmitter 16, switch 34 returns to its default position and allows data from cockpit controls 38 to reach flight controllers 42.

Evasive maneuvers can be predetermined and programmed into data processor 32. When control unit 30 is activated and switch 34 disengages cockpit controls 38, date processor 32 provides pitch, bank, and power data to flight controllers 42. Based upon the dynamics of the particular aircraft 10 in which control unit 30 is installed or determination of aviation experts and pilots, a set of safe evasive maneuvers can be predetermined for programming into data processor 32. These predetermined maneuvers can be adjusted or selected to account for specific flight information provided to control unit 30 by flight instruments 40. Information provided by flight instruments 40 can comprise attitude, altitude, turn, heading, velocity, as well as other commonly measured flight data provided to pilots.

Control unit 30 can also be used to allow friendly forces to remotely take control of aircraft 10 for execution of a safe landing in a designated area. In this embodiment of the present invention, antenna 36 receives predetermined coded signal 20 from a remote operator (not shown) located on the ground or in another aircraft, such as an AWACS airplane monitoring aircraft in the area. Receipt of properly coded signals 50 by antenna 36 activates switch 34, which disengages cockpit controls 38. Further coded signals transmitted to antenna 36 by remote operator 52 provide flight data for operation of flight controllers and aircraft 10 can thus be remotely piloted into a forced landing.

The system of the present invention may be used to impose on aircraft 10 a predetermined route or flight corridor programmed into the software of data processor 32. Deviation from the route would be recognized by control unit 30 as it is connected to flight instruments 40. Upon deviation, data processor 32 can activate switch 34 to disable pilot controls 38 and provide corrective data to flight controllers 42. According to this embodiment, there is no need for a ground transmitter to send signal 20 which diverts aircraft 10, as any deviations from the preprogrammed route will automatically activate control unit 30.

What is claimed is:

1. An apparatus for preventing the collision of an aircraft having a flight control system comprised of a set of pilot controls interconnected to a set of flight controls with a designated structure having a radar and a transmitter, said apparatus comprising:
an antenna capable of receiving a signal from said transmitter;
a data processor connected to said antenna; and
a switch connected to said data processor, said pilot controls and said flight controls, wherein said switch can disconnect said pilot controls from said flight controls and connect said data processor to said flight controls.

2. The apparatus of claim 1, wherein said data processor is programmed with predetermined evasive maneuvers.

3. The apparatus of claim 1, wherein said signal is encoded and said data processor is programmed to decode said signal.

4. The apparatus of claim 1, further comprising at least one flight instrument connected to said data processor.

5. The apparatus of claim 4, wherein said data processor is programmed to calculate an evasive maneuver which will avoid a collision with said structure based on data provided from said flight instrument.

6. A method of avoiding the collision of an aircraft having a flight control system comprised of a set of pilot controls connected to a set of flight controls with a designated structure having a radar and a transmitter, said method comprising:
sending a signal from said transmitter when said aircraft approaches nearer than a predetermined safe distance from said structure;
receiving said signal onboard said aircraft;
disengaging said pilot controls from said flight controls; and
providing said flight controls with a set of commands to avoid a collision.

7. The method of claim 6, wherein said set of commands are preprogrammed.

8. An apparatus for preventing the collision of an aircraft having a flight control system comprised of a set of pilot controls interconnected to a set of flight controls, comprising:
a GPS device located onboard said aircraft;
a data processor connected to said GPS device; and
a switch connected to said data processor, said pilot controls and said flight controls, wherein said switch can disconnect said pilot controls from said flight controls and connect said data processor to said flight controls.
